(19) United States
(12) Patent Application Publication
(10) Pub. No.: US 2024/0095446 A1
(43) Pub. Date: Mar. 21, 2024

(54) ARTIFICIAL INTELLIGENCE (AI) AND NATURAL LANGUAGE PROCESSING (NLP) FOR IMPROVED QUESTION/ANSWER SESSIONS IN TELECONFERENCES

(71) Applicant: INTERNATIONAL BUSINESS MACHINES CORPORATION, ARMONK, NY (US)

(72) Inventors: Avinash Tukaram Mane, Chinchwad (IN); Ratnakar Behera, Bangalore (IN); Sanket Jain, Gurgaon (IN); ZHENG XIE, Clontarf (IE); Krishnasuri Narayanam, Bangalore (IN); JOY PATRA, Dublin (IE)

(21) Appl. No.: 17/933,917

(22) Filed: Sep. 21, 2022

(51) Int. Cl. G06F 40/20; G06F 40/35

(52) U.S. Cl. CPC G06F 40/20; G06F 40/35

(57) ABSTRACT

Method, computer program product, and computer system are provided. Questions are extracted from a chat in real-time during an online meeting and are aggregated into groups of duplicate questions. The groups are presented to a subset of attendees whose question is in the group. Feedback is received and applied to the group from the subset of attendees. Whether a question is answerable is predicted. For answerable questions an amount of time to answer the question is predicted. The answerable questions are sequenced, filtered, prioritized, and presented to an attendee interface and a presenter interface.

### BACKGROUND

The present invention relates to computer systems, and more specifically to responses in live chat using artificial intelligence (AI) and natural language processing (NLP).

Recent health emergencies have increased the interest in teleconferencing as a useful technology to facilitate various types of meetings, including business meetings, doctor appointments, online classes, and town hall meetings. However, as participants increase, managing posts in the chat window becomes challenging. Issues include questions being overlooked in the chat traffic and not giving adequate attention to the more important questions. It may be a result that the meeting is rescheduled when the question/answer traffic is not adequately managed, resulting in increased time commitment from the participants, and thereby delaying the conclusion of the meeting's business.

It would be advantageous to include a dashboard that captures all questions, prioritizes, and links answers from content or script, for meetings in with medium (10-50) to large (50+) participants.

### SUMMARY

A method is provided. Questions are extracted from a chat in real-time during an online meeting and are aggregated into groups of duplicate questions. The groups are presented to a subset of attendees whose question is in the group. Feedback is received and applied to the group from the subset of attendees. Whether a question is answerable is predicted. For answerable questions an amount of time to answer the question is predicted. The answerable questions are sequenced, filtered, prioritized, and presented to an attendee interface and a presenter interface.

Embodiments are further directed to computer systems and computer program products having substantially the same features as the above-described computer-implemented method.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates the operating environment of a computer server, according to an embodiment of the present invention;

FIG. 2 illustrates an architecture for natural language processing (NLP) in real-time of live meetings, in accordance with one or more aspects of the present invention; and

FIG. 3 illustrates a process flow for NLP, in accordance with one or more aspects of the present invention.

### DETAILED DESCRIPTION

It is increasingly the case that employees work remotely and attend meetings using teleconferencing software. Similarly, students increasingly attend webinars using network-based applications, such as Zoom, and medical appointments can transpire using online technologies. Typically, one or more attendants monitor the chat window, and filter out the duplicate questions. The unique questions are read to the presenter to answer. This approach takes additional personnel to manage the presentation and/or meeting. Participants can repeat questions that were previously asked, thereby interrupting the flow of the meeting. The interruption may be major, for example, where there are several hundred attendees. Additionally, duplicate questions can create an impression that the attendees are not paying attention, or that the presenter is not clearly conveying the subject matter. It can occur that, even with the addition of the moderator, the presenter may respond to questions in a first come first served approach, which can leave the more relevant questions unanswered, as an unintended consequence. Therefore, embodiments of the present invention tend to improve time management through selecting the most filtered questions that are relevant to the topic. In the case of a meeting series, such as online classes, experience from prior sessions is captured in the model and leveraged to improve future NLP processing of transcripts.

However, as participants increase, managing posts in the chat window becomes challenging. Issues include questions being overlooked in the chat traffic and not giving adequate attention to the more important questions. It may be a result that the meeting is rescheduled when the question/answer traffic is not adequately managed, resulting in increased time commitment from the participants, and thereby delaying the conclusion of the meeting's business.

It would be advantageous to include a dashboard that captures all questions, prioritizes, and links answers from content or chat transcript. The dashboard can improve bidirectional communication efficiency and increase engagement by ensuring that all questions are heard and prioritized for receiving a response by importance. Embodiments of the present invention can present suggested answers from the presentation materials and chat transcript.

Embodiments of the present invention use NLP and intent recognition to train a model based on general teleconferencing content and scripts so that the model understands typical teleconferencing language. Additional layers of training can be build based on a series of a teleconference session, such as a training class or recurring status review meetings. Further, the model can be trained to customize NLP capabilities for particular groups, for example, for hardware engineers, so that the model is tailored for the cliches and acronyms of the group. Inputs to the model include past Q&A data from a stored source and current content from the meeting periodically captured according to a configurable schedule. The various embodiments can be implemented as an integrated supplementary component to a teleconferencing application, such as Zoom. The embodiments access various application programming interfaces (APIs) to access the data of the teleconferencing application, such as the chat transcript, the participants, and the meeting content. Also, the teleconferencing application performs audio to text captioning, which can be available through an API.

In real-time, during a meeting, the artificial intelligence (AI) based NLP engine identifies questions from the chat transcript, and groups similar questions together. The AI based NLP engine further understands the relevancy and complexity of a question and suggests answers from the presentation content and/or chat transcript. Questions are prioritized based on a configurable predetermined goal, such as the most relevant or most popular.

The dashboard includes a parking lot for questions that may not be answered during the live session. For each participant and for the presenter, the dashboard can include a web-based representation of questions grouped by topic, and for each group, the number of questions in the group as well as a suggested answer.

The AI NLP engine analyzes both open-ended and closed-ended questions. For closed-ended questions, where the response is not clearly limited to “yes” or “no” some factors to consider include whether the question is contextually and conceptually relevant to the topic of the agenda; spatial factors such as geographic location of the asker, and the profile, role, and seniority of the asker. The factors are additionally quantified by assigning weights which are then input to an algorithm, such as graph theory.

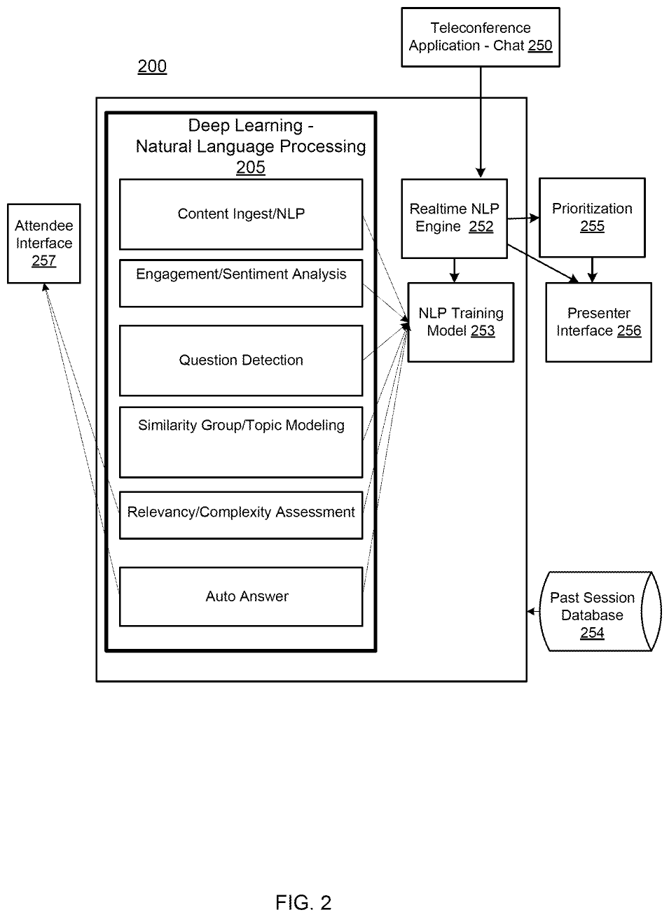

A meeting can comprise several main segments during which the deep learning NLP processing occurs. In the prep phase, the teleconferencing application initializes, which includes allocating the networking, etc., resources for the meeting. In the prep phase, the meeting content, i.e., the presentation materials, is loaded into the teleconferencing application. The main presentation phase begins when the presenter actually engages with the participants, thereby staring the meeting. During this phase, various models and algorithms of the deep learning NLP architecture is engaged to capture and analyze the chat input, as shown in FIG. 2. Typically, presenters plan meetings so that Q&A is deferred to end of the main presentation materials. This encourages participants to focus on the presentation materials, as it can occur that the question will be answered in them. Further, deferring the Q&A tends to improve the flow of the meeting, thereby promoting a deeper understanding by the participants. Also, this tends to encourage participant engagement and to improve the quality of the questions, as each question-and-answer prompts follow-on questions that build on the previously asked question. In the Q&A phase, the modeling and algorithms of the deep learning NLP architecture analyze the questions in the chat and prioritize them for presentation in the dashboard. In this phase, the past session database 254 is queried for previously asked questions and their associated answers.

The question analysis may be performed by a combination of various IBM Watson™ APIs. For example, IBM Watson™ Speech to Text enables speech transcription for use cases such as speech analytics. Speech is converted to text and analyzed for language patterns that can be tagged and categorized. Speech to text accommodates meetings where the question is verbalized rather than entered as text in a chat. The IBM Watson® Natural Language Understanding may extract metadata from text, such as entities, keywords, categories, sentiment, emotion, relations, and syntax. The IBM Watson™ Natural Language Classifier can be used to build custom text classification models to be used to perform Natural Language Processing (NLP) to tokenize and parse language into elemental pieces. The IBM Watson™ Assistant may be used to perform intent recognition. IBM Watson® Natural Language Understanding uses deep learning to extract meaning and metadata from unstructured text to discover categories, classifications, entities, keywords, sentiment, emotion, relations, and syntax. (IBM Watson® Natural Language Understanding is a registered trademark of IBM in the United States. IBM Watson™ Natural Language Classifier and IBM Watson™ Assistant are trademarks of IBM in the United States). IBM NLP includes parsing, stop-word removal, part-of-speech tagging, in addition to tokenizing. NLP processes free form natural language text into a standardized structure that can be input to other processing, as needed. It should be noted that in addition to the various IBM Watson APIs, other deep learning-based models and pre-trained transformer models can be used, for example the BERT language model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

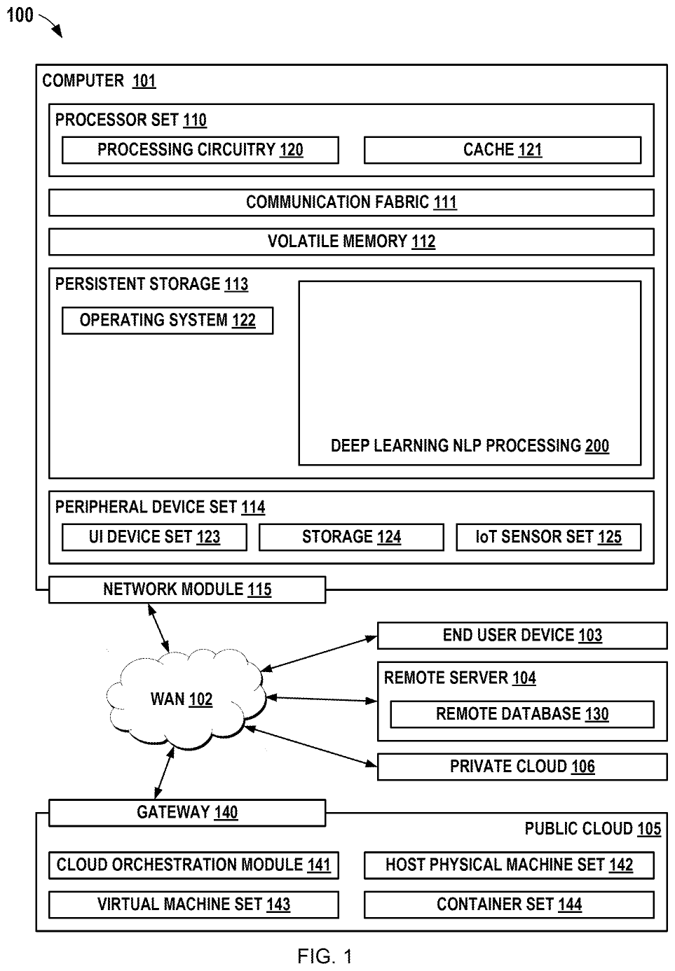

Beginning now with FIG. 1, an illustration is presented of the operating environment of a networked computer, according to an embodiment of the present invention.

Computing environment 100 contains an example of an environment for the execution of at least some of the computer code involved in performing the inventive methods, such as Deep Learning NLP (program) 205. In addition to block 205, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 205, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 205 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 205 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, an administrator that operates computer 101), and may take any of the forms discussed above in connection with computer 101. For example, EUD 103 can be the external application by which an end user connects to the control node through WAN 102. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

FIG. 2 illustrates an architecture 200 for natural language processing (NLP) in real-time for live meetings, in accordance with one or more aspects of the present invention.

The program 205 is integrated into the teleconferencing software and can call the APIs that the teleconferencing software exposes, including an API to make the chat activity available. Pre-training includes a machine learning model, e.g., BERT or the IBM Watson™ Natural Language Classifier, that is trained on a dataset of transcripts and previously asked questions and answers that are saved in past session database 254. The questions can be grouped by topic, complexity, frequency of presentation, and subject matter, among other factors. The transcripts can be from specialty teleconferences, such as training seminars on a technical topic, or general transcripts, such as from social club meetings. The machine learning model of the text classifier is trained using feature extraction based on past observations, such as the stored transcripts. To produce a classification model, a training data set is fed to the algorithm consisting of pairs of features and tags. After training, the model is fed with unseen text to predict which label to apply upon it. The classification algorithms predict the category of testing data sets based on the labels of training datasets.

The program 205 performs the following functions in real-time during a live teleconference. Engagement/sentiment analysis is performed using the NLP training model 253, following the pre-training.

The program 205 performs question detection through the pre-trained AI Transformer model with the addition of the chat transcript captured in the live meeting and the presentation content that was loaded prior to the meeting. Through grammatical analysis, the model uses NLP understand the structure of the chat input to determine whether it is a question or just a comment. An exemplary indication is the presence of one or more question mark symbols in the text, as is the presence of keywords such as “can,” “does,” “will.” etc. Multiple question mark symbols can indicate more than one nested question in the chat input. Additionally, both questions and comments can be limited to a configurable number of characters to promote multiple participants to participate in the live meeting, and also to avoid performance issues.

The program 205 further identifies and groups similar topics together through the pre-trained AI Transformer model and semantic analysis, with the addition of the chat transcript captured in the live meeting and the presentation content that was loaded prior to the meeting. Several factors may be considered, such as a count of the times the question was recognized, and a count of keywords that are found to match between the questions. To promote increased engagement by the participants, the length of the question may be limited a configurable number of characters or question segments, or a count of how many repetitions of the question are allowed. Latent Dirichlet Analysis (LDA) can also be used for topic modeling.

Once the chat input is determined to be a question, the pre-trained AI Transformer model uses NLP to identify the complexity level of the question. Additional modeling can be performed using such modeling and algorithms as BERT, Random Forest, and term frequency-inverse document frequency tf-idf). The modeling and algorithms can analyze the length of the question and the count of how many time the question was repeated within a configurable period of time can indicate a question that is relevant but not complex. Based on the analysis, the question can be assigned a relevancy score, where “0%” indicates a question of no or low relevancy and “100%” indicates a highly relevant question. Similarly, the question can be assigned a complexity score. A question can be determined to be relevant, but complex based on the length of the question, the number of segments in the question, and whether the question includes other nested questions. In an embodiment, the program 205 can assign weights to the questions, which can prioritize the questions based on relevance, with the higher the relevance increasing the priority by which the question is answered. A configurable count can limit the number of questions that are allowed for a given level of complexity. In an alternate method of question prioritization, questions above a configurable threshold of complexity can be batched together and asked as the end of the Q&A session, as they will likely require a lengthy answer.

The program 205 further maintains the meeting flow by auto answering the trivial questions, which can be those below a configurable level of complexity. Trivial questions are also those that tend to be asked frequently when the same presentation is given. This tends to minimize the number of parked questions. Frequently asked trivial questions can also indicate to the presenter that the presentation materials should be improved. These are the questions that may not be answered during the live session, for example, because the volume and/or complexity of questions exceeds the amount of time allotted at the end of the main presentation. The questions that the program 205 determines to be open-ended or closed-ended can be auto answered with either “yes” or “no” as appropriate for the question.

As the deep learning NLP processing 205 is live and real-time during the meeting, the results of the Q&A analyses are not only stored in the past session database 254 but are also applied real-time to update the real-time NLP engine 252.

Two dashboards are shown in FIG. 2 as attendee interface 257 and presenter interface 258. The interfaces show the statistics of questions that are asked during the meeting, as the program 205 calculates them. The statistics include the total number of questions being asked, the number of those that have not been answered (the open questions), and the number that have been auto answered. The interfaces also show a configurable number of top prioritized questions, the topic of the question, and how many questions were asked on that topic. Attendees can upvote or downvote the questions using the chat window and hashtags associated with the question. As the real-time NLP engine 252 is updated, the results are prioritized (255) for presentation in real-time at the interfaces.

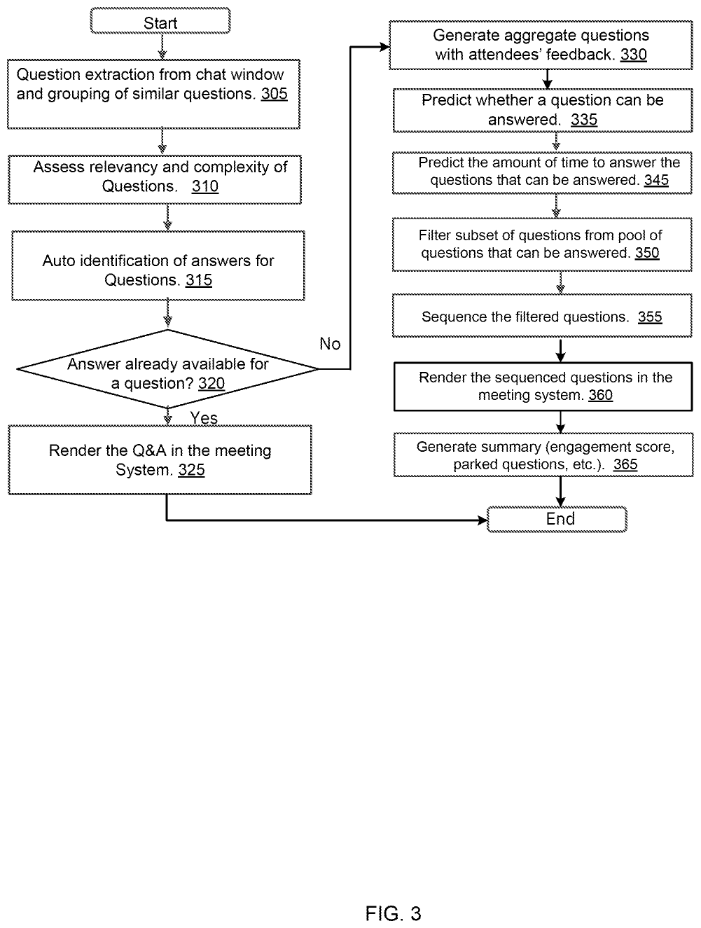

FIG. 3 illustrates a process flow for natural language processing (NLP) in real-time of live meetings, in accordance with one or more aspects of the present invention.

At 305, the program 205 extracts each question from the live chat, using an available API. Similar questions are grouped together.

At 310, the program 205 determines the relevancy and complexity of each question.

At 315, where possible, a question is identified for possible being answered automatically by the program 205.

At 320, the program 205 determines whether the question has already been answered, either previously or the answer can be located in the past session database 254.

At 325, if the answer is available, both the question and the answer is displayed in the meeting chat, and processing of the question ends.

If, at 320, an answer is not readily available, then processing continues at 330, where duplicate or similar questions are aggregated.

It is possible to use Natural Language Understanding and Natural Language Generation to generate summaries from input documents, such as chat transcripts and presentation content, while maintaining the integrity of the information. The questions can be aggregated based on degree of duplication, relevancy to the topic, and timing, i.e., the gap of time between two received questions. Multiple aggregate duplicate questions can be generated based on the categories of questions asked by the attendees. The aggregated question is presented to the attendees who asked questions that were its source for feedback. Since there is usually time in a meeting before the question/answer session, engaging with attendees can improve the accuracy of the aggregated question by iteratively regenerating and validating with the attendees. This also allows attendees to refine their questions or to ask completely different ones. Different subsets of attendees can be selected over the different iterations for diversity. Questions with low complexity can be aggregated with other low complexity questions, or may be aggregated with high complexity questions, but highly complex questions are not aggregated together. The topic of the question, e.g., is it a technology question, length of the questions, whether there are multiple parts/segments to the question, can be used to evaluate complexity. The lower the complexity of the questions in the aggregated questions, the more duplicate questions can be aggregated. Additionally, questions from the same geography, field of knowledge, or questions from users with similar profiles (as extracted from the teleconferencing application) can be aggregated.

At 335, the program 205 predicts whether a question can be answered. The presenter's profile, as extracted from the teleconferencing application, is considered in the prediction. The presenter profiles can be stored in the past session database 254, and each presenter can be associated with groups of similar historical questions from the presenter's past meetings. The probability of answering the current question is likely to increase if presenters with profiles similar to the current presenter have answered similar questions. Additionally, previous attendees' vote satisfaction recorded in the past session database 254 for similar questions can be considered. For example, if similar questions were not satisfactorily answered, then the predicted answer for the current question is not likely to be satisfactory. The more complex the question or the number of concepts in the question, it is less likely it is that the predicted answer will successfully answer the current question. To maintain responsiveness of the meeting software to the number of participants, a configurable threshold can be set such that only questions exceeding the threshold will be considered for prediction. Additionally, different thresholds can be configured for questions of different complexities, e.g., the threshold decreases as the complexity increases.

At 345, the program 205 predicts the amount of time to answer the questions that can be answered. As in 335 above, the presenter's profile can be considered in predicting the answering time for a question. For example, it can be predicted that the answering time of the current question will be more if presenters with similar profiles to the current presenter have historically taken a longer time to answer similar questions. A configurable threshold can define a range of times, such as a short time, an expected time, or a long time. These times can be set according to the topic of the meeting, such as technical seminar for engineers vs. a social meeting. The number of questions posted in the live chat can affect the time taken to answer a question. For example, when there is a high volume of questions, the presenter tends to have less time to dedicate to answering each question, with the impetus to answer as many questions as possible.

At 350, the program 205 filters a subset of questions from a pool of answerable questions. A set of questions having predicted answering probabilities, complexities, predicted answered times is input to the program 205. A mixed integer linear program (MILP) can be modeled to compute the subset of filtered questions, using the objective of maximizing the sum of answering probabilities of the questions filtered. Questions of interest to the larger attendee population are prioritized, whereas questions of interest to smaller groups of attendees can be filtered out. The sum of the predicted answering times for the filtered questions should be less than or equal to the Q&A session time. The presence or absence of a question in the output sequence is a decision variable.

At 355, the program 205 sequences the filtered questions. A set of questions having predicted answering probabilities, complexities, predicted answered times is input to the program 205. The output is an optimal sequencing of the answerable, filtered questions, with the objective of minimizing the distance between the related questions in the output sequence, and minimizing the distance between the questions that are posted by attendees from the same geographic region. Contextual factors, such as the relevancy of the question to the topic/agenda, and an attendee's conceptual factors, such as geographic region, profile, and previously asked questions are considered. Decision constraints include to order the questions in the increasing order of complexity, and decreasing order of predicted answering probability, and that any question is present only once in the output sequence. The position of a question in the output sequence is a decision variable.

At 360, the sequenced questions are displayed on the teleconferencing application, and the attendee interface 257 and presenter interface 258 are updated as described in FIG. 2.

What is claimed is:

1. A method, comprising:
extracting, by NLP, questions from chat window input in real-time during an online meeting;
aggregating the extracted questions into one or more groups of duplicate questions, based on one or more weighted factors;
presenting one or more group of duplicate questions to a subset of online meeting attendees;
predicting whether a question is answerable, based on a plurality of answerability factors;
based on determining that the question is answerable, predicting an amount of time to answer the answerable questions;
filtering and prioritizing a subset of questions from a pool of the answerable questions, based on a level of attendee interest, and a sum of predicted answering times being less than or equal to a Q&A session time;
sequencing the filtered and prioritized questions based on sequencing factors, wherein the sequencing factors include contextual factors and conceptual factors; and
updating both an attendee interface and a presenter interface with the sequenced questions.

2. The method of claim 1, wherein the weighted factors include a degree of duplication, relevancy to a meeting topic, category of question, and a gap of time between two received questions.

3. The method of claim 1, wherein the answerability factors include a presenter's profile as stored in a past session database, whether a presenter is associated with similar historical questions from the presenter's past meetings, attendees' satisfaction with the presenter's past meetings, and whether the presenter previously successfully answered similar questions.

4. The method of claim 1, wherein the subset of online meeting attendees comprises the online meeting attendees whose questions are included in the group of duplicate questions.

5. The method of claim 1, further comprising:
pre-training a plurality of AI transformer models using general teleconferencing content; and
customizing the pre-training of each model using additional content tailored to an audience.

6. The method of claim 1, further comprising:
iteratively receiving and applying feedback to the one or more group of duplicate questions from the subset of online meeting attendees, wherein the feedback includes agreement, disagreement, and a refinement.

7. The method of claim 1, further comprising displaying an interface with the meeting audio/video, wherein the interface shows:
a number of total questions;
a number of open questions;
a number of auto answered questions; and
a top question, including a count of askers and a topic.

8. A computer program product, the computer program product comprising a non-transitory tangible storage device having program code embodied therewith, the program code executable by a processor of a computer to perform a method, the method comprising:
extracting, by NLP, questions from chat window input in real-time during an online meeting;
aggregating the extracted questions into one or more groups of duplicate questions, based on one or more weighted factors;
presenting one or more group of duplicate questions to a subset of online meeting attendees;
predicting whether a question is answerable, based on a plurality of answerability factors;
based on determining that the question is answerable, predicting an amount of time to answer the answerable questions;
filtering and prioritizing a subset of questions from a pool of the answerable questions, based on a level of attendee interest, and a sum of predicted answering times being less than or equal to a Q&A session time;
sequencing the filtered and prioritized questions based on sequencing factors, wherein the sequencing factors include contextual factors and conceptual factors; and
updating both an attendee interface and a presenter interface with the sequenced questions.

9. The computer program product of claim 8, wherein the weighted factors include a degree of duplication, relevancy to a meeting topic, category of question, and a gap of time between two received questions.

10. The computer program product of claim 8, wherein the subset of online meeting attendees comprises the online meeting attendees whose questions are included in the group of duplicate questions.

11. The computer program product of claim 8, wherein the answerability factors include a presenter's profile as stored in a past session database, whether a presenter is associated with similar historical questions from the presenter's past meetings, attendees' satisfaction with the presenter's past meetings, and whether the presenter previously successfully answered similar questions.

12. The computer program product of claim 8, further comprising:
pre-training a plurality of AI transformer models using general teleconferencing content; and
customizing the pre-training of each model using additional content tailored to an audience.

13. The computer program product of claim 8, iteratively receiving and applying feedback to the one or more group of duplicate questions from the subset of online meeting attendees, wherein the feedback includes agreement, disagreement, and a refinement.

14. The computer program product of claim 8, further comprising displaying an interface with the meeting audio/video, wherein the interface shows:
a number of total questions;
a number of open questions;
a number of auto answered questions; and
a top question, including a count of askers and a topic.

15. A computer system, comprising:
one or more processors;
a memory coupled to at least one of the processors;
a set of computer program instructions stored in the memory and executed by at least one of the processors in order to perform actions of:
extracting, by NLP, questions from chat window input in real-time during an online meeting;
aggregating the extracted questions into one or more groups of duplicate questions, based on one or more weighted factors;
presenting one or more group of duplicate questions to a subset of online meeting attendees;
predicting whether a question is answerable, based on a plurality of answerability factors;
based on determining that the question is answerable, predicting an amount of time to answer the answerable questions;
filtering and prioritizing a subset of questions from a pool of the answerable questions, based on a level of attendee interest, and a sum of predicted answering times being less than or equal to a Q&A session time;
sequencing the filtered and prioritized questions based on sequencing factors, wherein the sequencing factors include contextual factors and conceptual factors; and
updating both an attendee interface and a presenter interface with the sequenced questions.

16. The computer system of claim 15, wherein the weighted factors include a degree of duplication, relevancy to a meeting topic, category of question, and a gap of time between two received questions.

17. The computer system of claim 15, wherein the answerability factors include a presenter's profile as stored in a past session database, whether a presenter is associated with similar historical questions from the presenter's past meetings, attendees' satisfaction with the presenter's past meetings, and whether the presenter previously successfully answered similar questions.

18. The computer system of claim 17, wherein the subset of online meeting attendees comprises the online meeting attendees whose questions are included in the group of duplicate questions.

19. The computer system of claim 15, further comprising:
pre-training a plurality of AI transformer models using general teleconferencing content; and
customizing the pre-training of each model using additional content tailored to an audience.

20. The computer system of claim 15, further comprising auto answering trivial questions, wherein trivial questions are those below a configurable level of complexity, and wherein auto answering trivial questions reduces a number of parked questions.
